(19) United States
(12) Patent Application Publication
(10) Pub. No.: US 2002/0023043 A1
(43) Pub. Date: Feb. 21, 2002

(54) System and method for supporting odd lot trading

(76) Inventors: Takao Samukawa, Kawasaki (JP); Fumihiko Otsuki, Kawasaki (JP); Shigehiko Terashima, Kawasaki (JP)

Correspondence Address: STAAS & HALSEY LLP, 700 11TH STREET, NW, SUITE 500, WASHINGTON, DC, 20001, US

(21) Appl. No.: 09/803,153

(22) Filed: Mar. 12, 2001

(30) Foreign Application Priority Data
Aug. 14, 2000 (JP) 2000-245699
Jan. 23, 2001 (JP) 2001-013934

(51) Int. Cl. G06F 17/60

(52) U.S. Cl. 705/37

(57) ABSTRACT

The object of the present invention is to provide technology that enable the securities firm to appropriately execute trading orders of the odd lot without making the price fluctuation risk and etc. come to the surface. First, odd lot buying orders or odd lot selling orders for a particular stock company is received (step S5). Next, it is judged whether or not the number of total buying order stocks of the odd lot or the number of total selling order stocks of the odd lot exceeds a predetermined threshold that is determined according to a predetermined rule (step S9). If it is judged that the number of total buying order stocks of the odd lot or the number of total selling order stocks of the odd lot exceeds a predetermined threshold that is determined according to a predetermined rule, a buying order of the round lot stock number defined for the particular stock company for the odd lot buying orders, a selling order of the round lot stock number for the odd lot selling orders is executed (step S11). Then, it is judged whether the number of total buying order stocks of the odd lot or the number of total buying order stocks of the odd lot is over the round lot stock number (step S17). If it is over the round lot stock number, the minimum number of ordered stocks among the odd lot buying orders or the odd lot selling orders is provided to all investors and unassigned stocks are provided to each remainder of the order according to the weighted average (step S19).

### TECHNICAL FIELD OF THE INVENTION

The present invention relates to the stock trading support technology, more particularly to the odd lot trading support technology.

### BACKGROUND OF THE INVENTION

Usually, the stocks of the stock company are traded in every round lot stock number. However, a case occurs in which the securities firm has to handle the trading orders of the odd lot, which is less than the round lot stock number. The odd lot occurs by the new stock apportionment issuance by the stock-split and the individual investor's trading in small lots. Conventionally, in principal, after orders of the odd lot were assembled and the number of total ordered stocks met the round lot stock number, securities firm made an order of the round lot stock number to the securities exchange in the same way as usual. In this conventional art, if the orders of the odd lot are assembled but the number of the total ordered stocks does not meet the round stock number within the day when investors order the trading of the odd lot, a problem will occur in the viewpoint of the customer service. This is because the order is not settled during that day. However, if the securities firm settles the orders of the odd lot from the customers, it may sustain a loss by the buying carryover or the selling carryover.

### SUMMARY OF THE INVENTION

Therefore, an object of the present invention is to provide technology that enable the securities firm to appropriately execute trading orders of the odd lot without making the price fluctuation risk and etc. come to the surface.

In addition, another object is to provide a new method for providing stocks to each order if the number of the total ordered stocks of the odd lot is over the round lot stock number.

A method of the first aspect of the present invention for supporting a trading of an odd lot that is less than a round lot stock number determined in every stock company comprises the steps of: receiving from a customer, an odd lot selling order or an odd lot buying order for a particular stock company and storing information of the order into a storage device (for example, step S5 in FIG. 2, or step S35 in FIG. 10); judging whether or not the number of total stocks of the odd lot selling orders or the number of total stocks of the odd lot buying orders received at the receiving step is over a threshold value that is less than the round lot stock number and is determined by a predetermined rule (for example, step S9 in FIG. 2 or step S39 in FIG. 10); and if it is judged at the judging step that the number of total stocks of the odd lot selling orders or the number of total stocks of the odd lot buying orders is over the threshold, generating a selling order of the round lot stock number defined for the particular stock company for the odd lot selling orders or a buying order of the round lot stock number defined for the particular stock company for the odd lot buying orders and outputting information of the order (for example, step S11 in FIG. 2, or step S41 in FIG. 10).

With this configuration, even if the number of the total ordered stocks of the odd lot does not meet the round lot stock number, it becomes possible to settle the orders from customers at the moment when, for example, the odd lot trading orders whose total ordered stock number makes the trading fee of the odd lot trading orders exceed a risk amount caused by the buying carryover or the selling carryover are received. Therefore, the risk of the securities firm becomes low, and it becomes possible to settle customers' orders in an earlier stage.

A method of the second aspect of the present invention for supporting a trading of a odd lot that is less than a round lot stock number determined in every stock company comprises the steps of: judging whether or not the number of total stocks of the odd lot selling orders or the number of total stocks of the odd lot buying orders received as to a particular stock company from customers is over the round lot stock number for the particular stock company (for example, step S17 in FIG. 2 or step S47 in FIG. 10); if it is judged at the judging step that the number of total stocks of the odd lot selling orders or the number of total stocks of the odd lot buying orders is over the round lot stock number for the particular stock company, judging whether it is possible to assign the minimum number of ordered stocks of the odd lot selling orders or the odd lot buying orders to each customer who makes the odd lot selling order or the odd lot buying order (for example, step S61 in FIG. 7, step S81 in FIG. 11); if it is judged at the second judging step that it is possible to assign the minimum number of ordered stocks, assigning the minimum number of ordered stocks to each customer who makes the odd lot selling order or the odd lot buying order, and storing into a storage device, information representing the settlement state (for example, step S63 in FIG. 7 or step S83 in FIG. 11); and assigning the remainder of the stock number to a customer who has the remainder of the order according to a predetermined rule and storing into the storage device the information representing the settlement state (for example, step S67 in FIG. 7 or step S87 in FIG. 11) wherein the remainder of the stock number is calculated by subtracting the total stock number provided at the step of providing the minimum ordered stock number from the round lot stock number.

With this configuration, it becomes possible to provide stocks to each customer without causing strains as compared to the conventional art.

### BRIEF DESCRIPTION OF THE DRAWINGS

FIG. 1 is a diagram of a system outline of one embodiment of the present invention;

FIG. 2 is a flowchart that shows a flow for processing the odd lot buying order;

FIG. 3 shows an example of a screen representing a price, buying order insufficiency, selling order insufficiency and etc;

FIG. 4 shows an example of a screen for inputting an order;

FIG. 5 shows an example of a format of order data;

FIG. 6 shows an example of an order refusing screen;

FIG. 7 shows a flow of the stock providing processing if the number of total ordered stocks is over the round lot stock number;

FIG. 8 shows an example of a processing result if the stock providing processing is performed according the processing flow shown in FIG. 7;

FIG. 9A shows another example of a processing result if the stock providing processing is performed according the processing flow shown in FIG. 7;

FIG. 9B shows an example of a processing result if the stock providing processing is performed by the simple weighted average;

FIG. 10 is a flowchart that shows a flow for processing the odd lot buying order; and

FIG. 11 shows a flow of the stock providing processing if the number of total ordered stocks is over the round lot stock number.

### DETAIL DESCRIPTION OF THE PREFERRED EMBODIMENTS

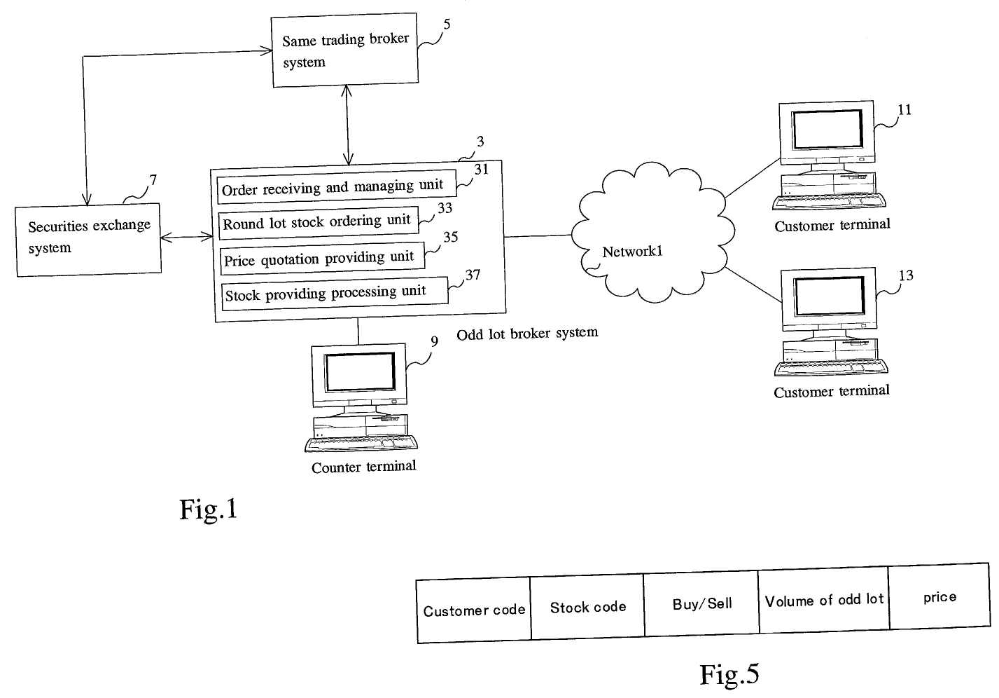

The system outline of an embodiment of the present invention is explained using FIG. 1. An odd lot broker system 3 is a main system in the present invention managed by a securities firm, which receives an odd lot trading order. A securities exchange system 7 is connected to the odd lot broker system 3, and is a system for executing the trading of stocks listed in the securities exchange. The securities exchange system 7 has no difference with the conventional art. Therefore, further explanation is omitted here. A same trading broker system 5 is connected to the odd lot broker system 3, and can receive odd lot trading information from the odd lot broker system 3 and can transmit odd lot order information to the odd lot broker system 3.

One or a plurality of counter terminals 9 are also connected to the odd lot broker system 3. This counter terminal 9 is placed on, for example, the counter of the securities firm, which receives the odd lot orders. It is a terminal for displaying the odd lot trading information and inputting the odd lot order information to the odd lot broker system 3. The counter terminal 9 may be placed on not only the counter but also a call center or offices in the securities firm. Furthermore, an operator who operates the counter terminal 9 may be a staff of the shop of the securities firm or a customer (also called as investor) himself or herself.

The odd lot broker system 3 has an order receiving and managing unit 31 for receiving the odd lot orders from the counter terminal 9 or customer terminal 11 or 13, for providing calculated differences between the round lot stock number and the number of the total ordered stocks of the odd lot for the customers and etc. and for performing processing such as storing into a storage device the stock number provided to each order and the remainder of the order. The odd lot broker system 3 also has a round lot stock ordering unit 33 for determining the timing to output an order of the round lot stock number to, for example, the securities exchange system 7 based on a predetermined standard, and for issuing the order at that timing. Furthermore, the odd lot broker system 3 has a stock price quotation providing unit 35 for acquiring information such as a stock price from, for example, the securities exchange system 7 and for providing the information for the customers, and a stock providing processing unit 37 for determining stock numbers which are provided to each customer if the number of the total ordered stock of the odd lot is over the round lot stock number. The explanation of processing contents of these units is described below.

The odd lot broker system 3 is connected to a network 1, for example, the Internet. Through this network 1, the odd lot broker system 3 is connected with the customer terminal 11 and 13, which are operated by the customers. That is, the customer is capable to perform so-called online stock trading. However, the number of the customer terminal is not limited to “2”.

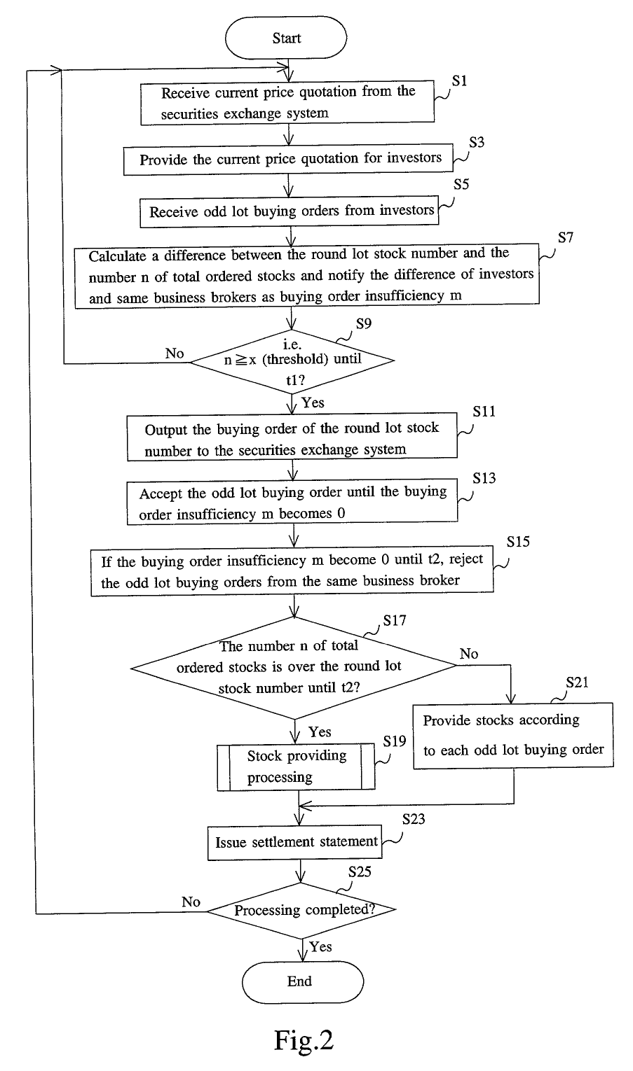

Next, a processing flow of the odd lot broker system 3, which processes the odd lot buying orders, is explained using FIG. 2 to FIG. 9. First, the stock price quotation providing unit 35 of the odd lot broker system 3 receives the current prices of predetermined stocks from the securities exchange system 7 (step S1). The predetermined stocks are stocks for which the odd lot order may be made. When the stock price quotation providing unit 35 of the odd lot broker system 3 receives information concerning the current prices of the predetermined stocks, it temporarily stores it into the storage device. Then, the stock price quotation providing unit 35 provides the current price quotation received from the securities exchange system 7 for investors via the counter terminal 9 and the customer terminal 11 and 13 (step S3). For example, in response to accesses to the odd lot broker system 3 by the investors and etc., the stock price quotation providing unit 35 transmits the current price quotation to the counter terminal 9 and the customer terminal 11 and 13, which are sources of the accesses. The counter terminal 9 and the customer terminal 11 and 13 displays the current price quotation on the display device. The same processing at the step Si and S3 is also performed by the same trading brokers for their customers.

The order receiving and managing unit 31 of the odd lot broker system 3 receives odd lot buying orders of the predetermined stock from investors (step S5). That is, the investors can operates the counter terminal 9 and the customer terminal 11 and 13, and transmit the odd lot buying orders to the odd lot broker system 3. The same trading broker system 5 can also transmit the odd lot buying orders to the odd lot broker system 3. Then, the order receiving and managing unit 31 of the odd lot broker system 3 stores the information concerning the odd lot buying order into the storage device. However, at this moment, the buying order is not output to the securities exchange system 7.

Then, the order receiving and managing unit 31 calculates a difference between the round lot stock number and the number n of the total buying order stock, and notifies the difference of the investors and the same trading broker system 5 as buying order insufficiency m (step S7). In response to accesses to the odd lot broker system 3 from the investors, the order receiving and managing unit 31 transmits the buying order insufficiency m, which is calculated in advance and stored in the storage device, to the counter terminal 9 and the customer terminal 11 and 13, which are sources of the accesses. The counter terminal 9 and the customer terminal 11 and 13 display the buying order insufficiency m on the display device.

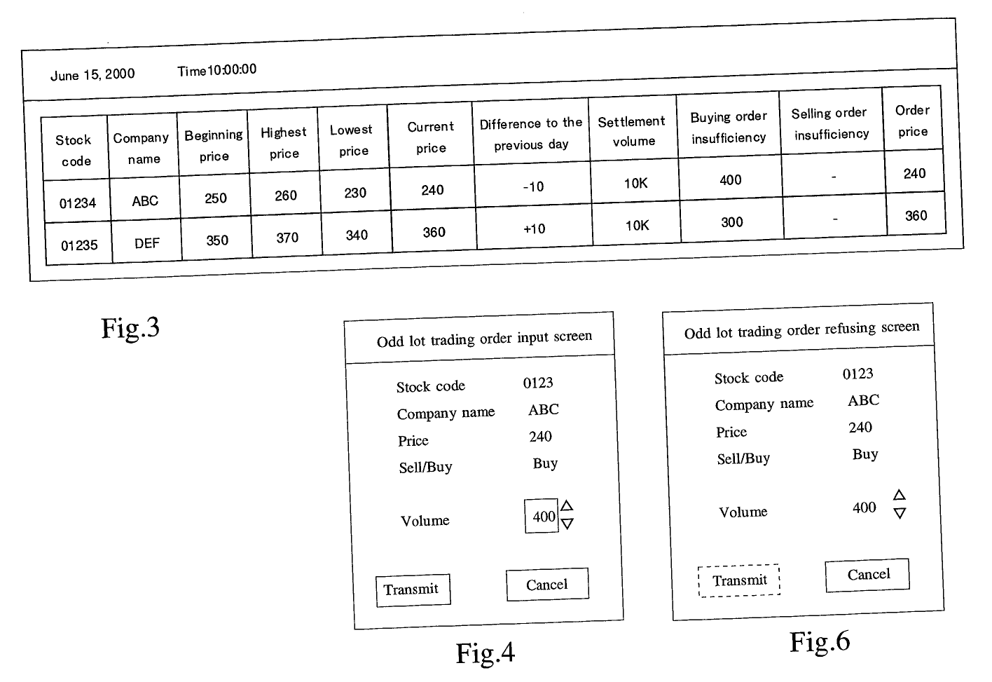

For example, the display shown in FIG. 3 is performed. In FIG. 3, information concerning day and time is displayed on the top. As to stocks (here, stock codes 01234 and 01235) for which the odd lot orders can be made, columns for stock codes, company names (stock company name), beginning prices, highest prices, lowest prices, current prices, difference to the previous day (a difference between the current price and the final price on the previous day), settlement volumes, buying order insufficiency, selling order insufficiency, and order prices are provided. The selling order insufficiency means a difference between the round lot stock number and the number of the total selling order stocks of the odd lot. Because FIG. 3 shows a scene to explain the buying order of the odd lot, no number is displayed for the selling order insufficiency. However, if the system is configured to handle both of buying and selling orders on this screen, it is possible to display the selling order insufficiency. In addition, FIG. 3 includes a column for prices. However, because the investors cannot make a limit order in this embodiment, the price at the ordering time may not be applied to the odd lot order. Therefore, the aforementioned “order price” has the same meaning as the current price and it may be unnecessary to provide the price column in addition to the current price column.

For example, if the stock code in FIG. 3 is clicked, the screen as shown in FIG. 4 is displayed on the counter terminal 9 and etc. Here, the screen includes columns for the stock code, the company name, the price, indication whether sell or buy, volume, which is changeable, and a button for transmission and a button for cancel. The volume, which is equal to or less than the buying order insufficiency shown in FIG. 3, for example, may be specified. In addition, it is also possible to configure the system to accept orders whose volume is over the buying order insufficiency, for the counter terminal 9 and the customer terminal 11 and 13, and to accept only orders whose volume is equal to or less than the buying order insufficiency for the same trading broker system 5. As described above, the price does not have to be displayed. If the button for transmission is clicked in FIG. 4, the odd lot buying order is transmitted to the order receiving and managing unit 31 from the counter terminal 9 and etc. The order can be canceled by clicking the cancel button.

FIG. 5 shows an example of a data format transmitted to the odd lot broker system 3 if the investor instructs the odd lot buying order in the counter terminal 9 and etc. The data includes the customer code of the investor who made the odd lot buying order, the stock code, the distinction of buying or selling (for example, “1”, means selling and “2” means buying.), the volume of the odd lot, and the price. As described above, the price data may be unnecessary.

The order of step S5 and step S7 in FIG. 2 may be changed. In addition, step S5 and step S7 may be executed simultaneously.

Next, the round lot stock ordering unit 33 of the odd lot broker system 3 determines whether the number n of the total buying order stocks of the odd lot becomes equal to or higher than a predetermined threshold x as a result of accepting the odd lot buying orders until a predetermined timing t1 (step S9). The predetermined timing t1 is set according to, for example, a timing to update the stock price information. The predetermined threshold x has a lot of variations but for example, is determined as follows.

For example, suppose a state in which the securities firm can get the trading fee which is 3% of the trading contracted price. Then, for example, if the round lot stock number is 1000 and the trading has been made with the unit price 9000 Yen, the trading fee is 270000 Yen, which is 3% of the price 9000000 Yen for 1000 stocks. The securities firm gets 270000 Yen as sales. If the number of the total buying order stocks of the odd lot becomes 990 stocks until the predetermined timing t1, the trading fee is 267000 Yen, which is 3% of the price 8910000 Yen for 990 stocks. On the other side, if the investors do not make any orders for 10 stocks that is the buying order insufficiency, the securities firm buys 1000 stocks from the securities exchange and sells 990 stocks to the investors. At this moment, the maximum loss (a risk amount) caused by the buying remainder is 90000 Yen, which is the price for 10 stocks. On the other side, since the trading fee is 267300 Yen, it is higher than 90000 Yen, which is the maximum loss. Therefore, the securities firm gets profits 177300 Yen. In another case, if the number of the total buying order stocks of the odd lot becomes 980 stocks, the trading fee is 264600 Yen, which is 3% of the price 8820000 Yen for 980 stocks. On the other hand, if the investors do not make any order for 20 stocks, which is the buying order insufficiency, the securities firm gets 1000 stocks from the securities exchange and sells 980 stocks to the investors. At this moment, the maximum loss caused by the buying remainder is the price 180000 Yen for 20 stocks. Therefore, the securities firm gets profits 84600 Yen, which is the difference between the trading fee 264600 Yen and the maximum loss 180000 Yen caused by the buying remainder. If the loss caused by the buying remainder is made larger in such a way, the number of stocks, which is the lowest to give profits to the securities firm, is calculated. An expression of inequality is as follows: (1000−x)* 9000<0.03. The left side represents the loss caused by the buying remainder and the right side represents the trading fee. X is the threshold of the buying remainder stock number. If the above described inequality is solved, 970.9<x is obtained. If the rate of the trading fee is changed, the threshold x is also changed.

If it is judged at the step S9 that n is equal to or larger than x until t1, the round lot stock ordering unit 33 generates a buying order of the round lot stock number and outputs the buying order of the round lot stock number to the securities exchange system 7 (step S11). With this, the securities exchange system 7 processes the buying order as usual, and, for example, settles the buying order of the round lot stock number without limit. If the buying order of the round lot stock number is transmitted to the securities exchange system 7, the round lot stock ordering unit 33 stores information concerning the buying order of the round lot stock number (including the stock price information and etc.) into the storage device. If it is judged at the step S9 that n is less than x, processing returns to step S1.

As described above, if the threshold x is determined and the buying order of the round lot stock number is executed for the securities exchange before the number of the total ordered stocks does not reach the round lot stock number, the securities firm can settle the buying orders of the odd lot from the investors in an earlier stage compared with the conventional art. However, since the maximum loss caused by the buying remainder is covered by the trading fee, Aid the risk of the securities firm becomes low.

In this embodiment, since the buying order of the round lot stock number is executed for the securities exchange before the number of the total buying order stocks does not reach the round lot stock number, the buying order insufficiency m is not zero even if the buying order is executed for the securities exchange. Therefore, the order receiving and managing unit 31 of the odd lot broker system 3 accepts the buying order from the counter terminal 9, the customer terminal 11 and 13, and the same trading broker system 5 until the buying order insufficiency m becomes 0 in principal to dispose of the buying remainder (step S13). However, the order receiving and managing unit 31 does not always reject the buying order at the moment when the buying order insufficiency m becomes 0. An investor may make an order whose stock number exceeds the buying order insufficiency m, and a plurality of investors may almost simultaneously make orders and the orders may make the buying order insufficiency m 0. In such cases, the order receiving and managing unit 31 accepts the buying orders. Information concerning the received buying order is stored into the storage device. In addition, it is possible to limit acceptances of the buying orders before a predetermined timing t2. For example, the predetermined timing t2 is the end of the business hours.

If the buying order insufficiency m becomes 0 until the predetermined timing t2, the order receiving and managing unit 31 rejects the buying orders from the same trading broker system 5 (step S15). On the other side, it is possible to accept the buying orders from the investors because of the customer service even if the buying order insufficiency m becomes 0. If the buying order is rejected, even when the stock code is clicked, for example, in FIG. 3, a screen as shown in FIG. 6 is displayed. That is, the display contents are almost unchanged from FIG. 2 to FIG. 3. However, on the screen, the volume of the order cannot be changed and the button for transmission cannot be clicked. Here, only the cancel button can be clicked.

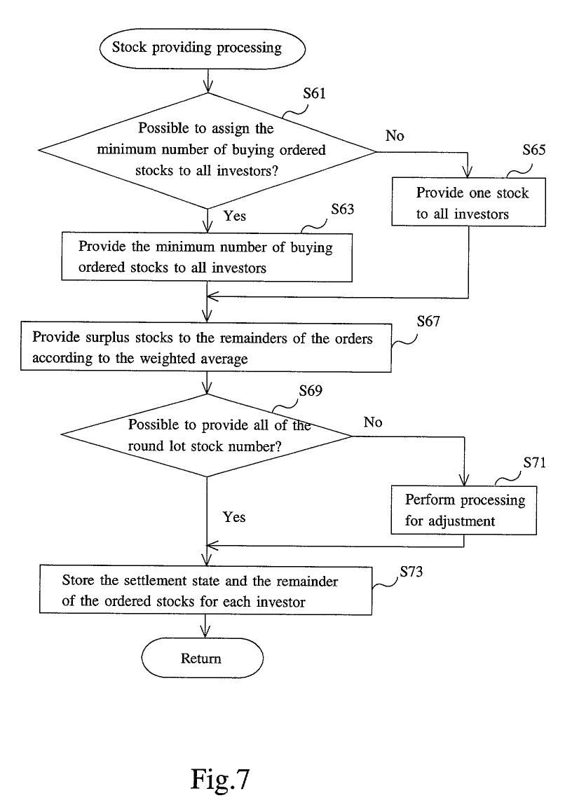

Then, the order receiving and managing unit 31 judges whether the number n of the total buying order stocks exceeds the round lot stock number until the predetermined timing t2 (step S17). If the number n of the total buying order stocks exceeds the round lot stock number, the stock providing processing unit 37 performs the stock providing processing which will be explained using FIG. 7 (step S19). On the other hand, if the number n of the total buying order stocks is equal to or less than the round lot stock number, the order receiving and managing unit 31 provides stocks according to each buying order, and stores information concerning the stock providing state into the storage device (step S21).

After step S19 or step S21, in accordance with the stock settlement state, each odd lot buying order is settled and an amount of money, which the investor has to pay, is calculated by adding the price for stocks and the trading fee and tax, and the settlement statement is issued for the investor (step S23). Then, it is judged whether processing has to be ended (step S25).

If processing has to continue, it returns to step S1. If it is judged that the processing has to be ended, go to end.

By performing such a processing, the odd lot order can be settled even if the number of the total ordered stocks of the odd lot does not reach the round lot stock number. In addition, the customer service can be improved.

Next, the details of step S19 are explained using FIG. 7 to FIG. 9. The stock providing processing unit 37 firstly judges whether or not it is possible to provide the minimum number of ordered stocks among the accepted buying orders to all investors who made the buying orders (step S61). If it is possible to provide the minimum number of ordered stocks to all investors, the stock settlement processing unit 37 provides the minimum number of ordered stocks to all investors, and stores information concerning the settlement state (step S63). On the other side, if it is impossible to provide the minimum number of ordered stocks among the received buying orders to all investors, first of all, one stock is provided to all investors and stores information concerning the settlement state (step S65). For example, if the buying orders are accepted from 4 investors and the minimum number of ordered stocks is 300 stocks, the provided stocks becomes 1200 stocks and exceeds the round lot stock number when 300 stocks are provided to 4 investors. In such a case, it is impossible to provide the minimum number of ordered stocks. Therefore, one stock is provided to 4 investors at step S65.

After step S63 or step S65, the stock providing processing unit 37 provides the stocks, which is unassigned by the processing at step S63 or S65, by the weighted average of the remainder of the order to each investor who has the remainder of the order, and stores information concerning the settlement state into the storage device (step S67). Then, the stock providing processing unit 37 judges whether or not it is possible to provide all of the round lot stocks by the processing step S63 or S65 and step S67 (step S69). If it is possible to provide all of the round lot stocks, the settlement state and the remainder number of the ordered stocks are stored for each investor into the storage device (step S73). On the other side, if it is not possible to provide all of the round lot stock number and the remainder occurs, processing for adjusting the remainder is performed (step S71). Then, step S73 is performed.

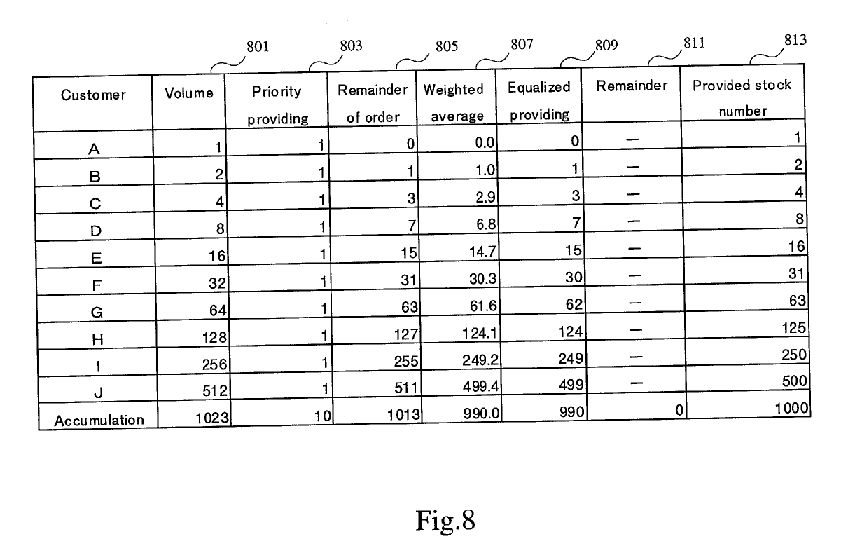

The processing of FIG. 7 is explained using a particular example. FIG. 8 shows a result of the stock providing processing in this embodiment. As shown in column 801 for the volume, the number of ordered stocks for each investor is 1 for investor A, 2 for investor B, 4 for investor C, 8 for investor D, 16 for investor E, 32 for investor F, 64 for investor G, 128 for investor H, 256 for investor I, and 512 for investor J. Here, the minimum number of ordered stocks is 1 for investor A. Therefore, as shown in column 803 for priority providing, the stock number provided at step S63 is 1. The remainder of the order after the providing processing at step S63 is performed is the stock number shown in column 805 for the remainder of the order.

Namely, the remainder of the order is 0 for investor A, 1 for investor B, 3 for investor C, 7 for investor D, 15 for investor E, 31 for investor F, 63 for investor G, 127 for investor H, 255 for investor I, and 511 for investor J. The value of the weighted average of this remainder of the order is calculated and is shown in column 807 for the weighted average. That is, the value of weighted average is 0.0 for investor A, 1.0 for investor B, 2.9 for investor C, 6.9 for investor D, 14.7 for investor E, 30.3 for investor F, 61.6 for investor G, 124.1 for investor H, 249.2 for investor I, and 499.4 for investor J. If unassigned stocks are provided with adjustments of the odd according to the calculated value of the weighted average. The result of the providing is shown in column 809 for equalized providing. Namely, the number of provided stocks according to the weighted average is 0 for investor A, 1 for investor B, 3 for investor C, 7 for investor D, 15 for investor E, 30 for investor F, 62 for investor G, 124 for investor H, 249 for investor I, and 499 for investor J. If such a providing processing is performed, as shown in row for accumulation of the column 803 for the priority providing and the column 809 for the equalized providing, all of the round lot stock number, that is, 1000 stocks (=10+990), are provided (column 813). Therefore, the finally provided stock number is, as shown in column 813 for the provided stock number, 1 for investor A, 2 for investor B, 4 for investor C, 8 for investor D, 16 for investor E, 31 for investor F, 63 for investor G, 125 for investor H, 250 for investor I, and 500 for investor J.

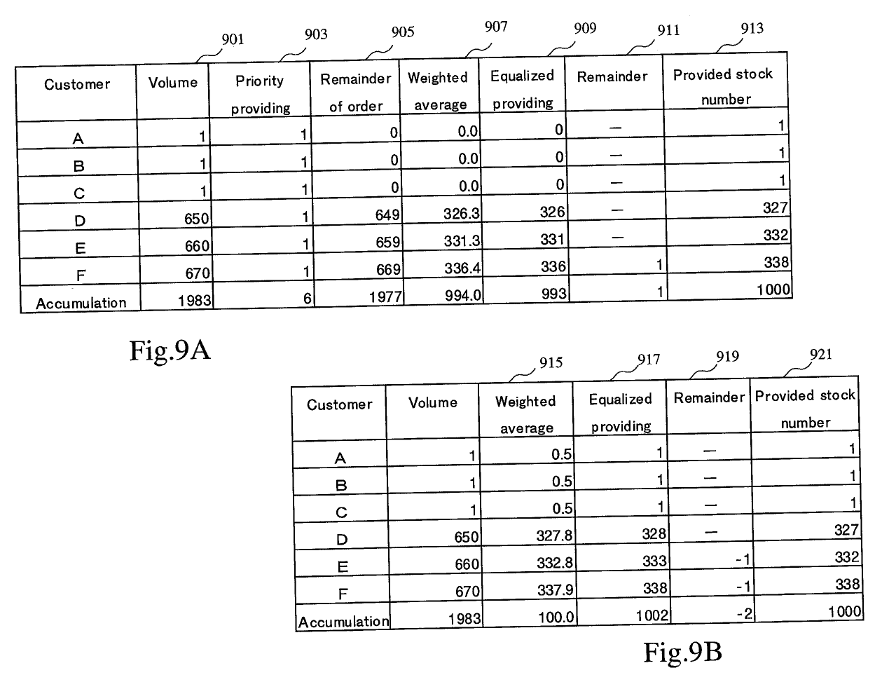

Another result of the stock providing processing is shown in FIG. 9A. As shown in column 901 for the volume, the number of ordered stock for each investor is 1 for investor A, 1 for investor B, 1 for investor C, 650 for investor D, 660 for investor E, and 670 for investor F. Here, the minimum number of ordered stocks is 1 for investor A, B and C.

Therefore, as shown in column 903 for priority providing, the stock number provided at step S63 is 1. The remainder of the order after the providing processing at step S63 is performed is the stock number shown in column 905 for the remainder of the order. Namely, the remainder of the order is 0 for investor A, 0 for investor B, 0 for investor C, 649 for investor D, 659 for investor E, and 669 for investor F. The value of the weighted average of this remainder of the order is calculated and is shown in column 907 for the weighted average. That is, the value of weighted average is 0.0 for investor A, 0.0 for investor B, 0.0 for investor C, 326.3 for investor D, 331.3 for investor E, and 336.4 for investor F. If unassigned stocks are provided with adjustments of the odd according to the calculated value of the weighted average. The result of the providing is shown in column 909 for equalized providing. Namely, the number of provided stocks according to the weighted average is 0 for investor A, 0 for investor B, 0 for investor C, 326 for investor D, 331 for investor E, and 336 for investor F. If such a providing processing is performed, as shown in row for accumulation of the column 903 for the priority providing and the column 909 for the equalized providing, not all of the round lot stock number, 999 stocks (=6+993), are provided. Therefore, the remainder is 1 in this example (column 911). Then, the remainder 1 is provided to investor F who has the maximum number of the remainder of the order. Thus, the finally provided stock number is, as shown in column 913 for the provided stock number, 1 for investor A, 1 for investor B, 1 for investor C, 327 for investor D, 332 for investor E, and 338 for investor F.

On the other hand, FIG. 9B shows an settlement state in which the round lot stock number is provided to orders, which is the same as shown in FIG. 9A, according to the simple weighted average of the ordered stock number. In this example, the value of the weighted average is shown in column 915 for the weighted average. That is, the value is 0.5 for investor A, 0.5 for investor B, 0.5 for investor C, 327.8 for investor D, 332.8 for investor E, and 337.9 for investor F. If unassigned stocks are provided with adjustments of the odd according to the calculated value of the weighted average. The result of the providing is shown in column 917 for equalized providing. Namely, the number of provided stocks according to the weighted average is 1 for investor A, 1 for investor B, 1 for investor C, 328 for investor D, 333 for investor E, and 338 for investor F. If such a providing processing is performed, as shown in row for accumulation of the column 917 for the equalized providing, not all of the round lot stock number, 1002 stocks, are provided. Therefore, the remainder is −2 in this example (column 919). Then, the remainder −1 is provided to investor E and F who make orders including a lot of stocks. Thus, the finally provided stock number is, as shown in column 921 for the provided stock number, 1 for investor A, 1 for investor B, 1 for investor C, 328 for investor D, 332 for investor E, and 337 for investor F.

Thus, if the providing processing is performed in accordance with this embodiment, it becomes possible to provide stocks in a manner in which the strains is made small compared to the providing according to the simple weighted average.

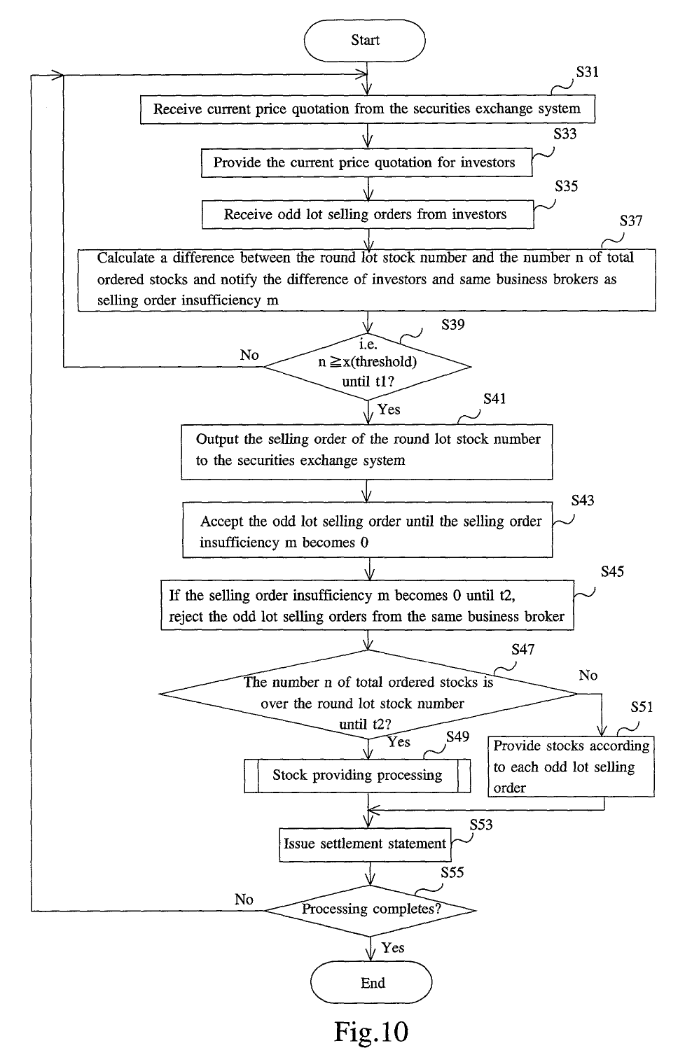

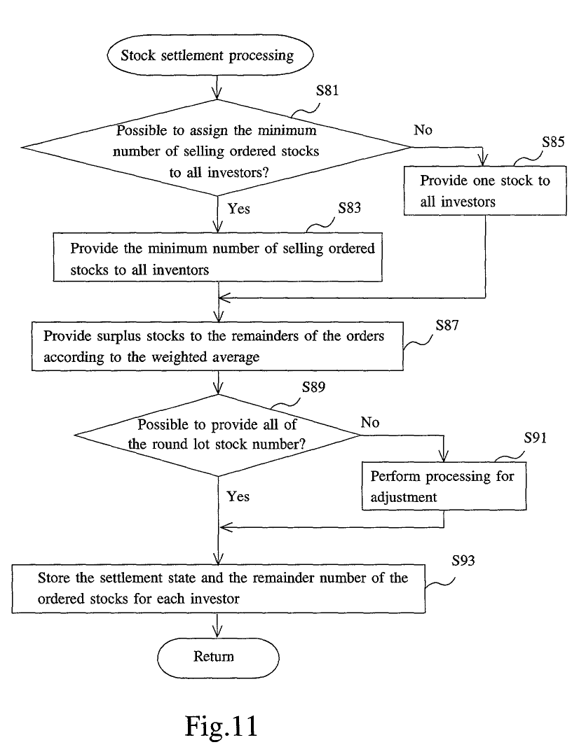

FIG. 2 shows processing for the odd lot buying order. Next, a processing flow of the odd lot broker system 3, which processes the odd lot selling orders, is explained using FIG. 10 and FIG. 11. First, the stock price quotation providing unit 35 of the odd lot broker system 3 receives the current prices of predetermined stocks from the securities exchange system 7 (step S31). When the stock price information providing unit 35 of the odd lot broker system 3 receives quotation concerning the current prices of the predetermined stocks, it temporarily stores it into the storage device. Then, the stock price quotation providing unit 35 provides the current price quotation received from the securities exchange system 7 for investors via the counter terminal 9 and the customer terminal 11 and 13 (step S33). For example, in response to accesses to the odd lot broker system 3 by the investors and etc., the stock price quotation providing unit 35 transmits the current price quotation to the counter terminal 9 and the customer terminal 11 and 13, which are sources of the accesses. The counter terminal 9 and the customer terminal 11 and 13 displays the current price quotation on the display device. The same processing at the step S1 and S3 is also performed by the same trading brokers for their customers.

The order receiving and managing unit 31 of the odd lot broker system 3 receives odd lot selling orders of the predetermined stock from investors (step S35). That is, the investors can operates the counter terminal 9 and the customer terminal 11 and 13, and transmit the odd lot selling orders to the odd lot broker system 3. The same trading broker system 5 can also transmit the odd lot selling orders to the odd lot broker system 3. Then, the order receiving and managing unit 31 of the odd lot broker system 3 stores the information concerning the odd lot selling order into the storage device. However, at this moment, the selling order is not output to the securities exchange system 7.

Then, the order receiving and managing unit 31 calculates a difference between the round lot stock number and the number n of the total selling order stock, and notifies the difference of the investors and the same trading broker system 5 as selling order insufficiency m (step S37). In response to accesses to the odd lot broker system 3 from the investors, the order receiving and managing unit 31 transmits the selling order insufficiency m, which is calculated in advance and stored in the storage device, to the counter terminal 9 and the customer terminal 11 and 13, which are sources of the accesses. The counter terminal 9 and the customer terminal 11 and 13 display the selling order insufficiency m on the display device.

For example, the display shown in FIG. 3 is performed. Because FIG. 3 is for explaining the odd lot buying order, the selling order insufficiency is not shown. However, at this scene, the selling order insufficiency need to be shown. In addition, the column for the price is handled in the same way as in the buying order. For example, if the stock code in FIG. 3 is clicked, the screen as shown in FIG. 4 is displayed on the counter terminal 9 and etc. However, indication whether buying or selling must be “selling” instead of “buying.” If the button for transmission is clicked in FIG. 4, the odd lot selling order is transmitted to the order receiving and managing unit 31 from the counter terminal 9 and etc. The order can be canceled by clicking the cancel button.

The order of step S35 and step S37 in FIG. 10 may be changed. In addition, step S35 and step S37 may be executed simultaneously.

Next, the round lot stock ordering unit 33 of the odd lot broker system 3 determines whether the number n of the total selling order stocks of the odd lot becomes equal to or higher than a predetermined threshold x as a result of accepting the odd lot selling orders until a predetermined timing t1 (step S39). The predetermined timing t1 is set according to, for example, a timing to update the stock price information. The predetermined threshold x has a lot of variations. But, for example, as described above, it can be determined by the trading fee and the maximum loss of the selling remainder. If it is supposed that the securities firm can get the trading fee which is 3% of the trading contracted price and the round lot stock number is 1000 and the trading has been made with the unit price 9000 Yen, the threshold x is expressed by the inequality (1000−x)*9000<0.03. The left side represents the loss caused by the selling remainder and the right side represents the trading fee. X is the threshold of the selling remainder stock number. If the above described inequality is solved, 970.9<x is obtained. If the rate of the trading fee is changed, the threshold x is also changed.

If it is judged at the step S39 that n is equal to or larger than x until t1, the round lot stock ordering unit 33 generates a selling order of the round lot stock number and outputs the selling order of the round lot stock number to the securities exchange system 7 (step S41). With this, the securities exchange system 7 processes the selling order as usual, and, for example, settles the selling order of the round lot stock number without limit. If the selling order of the round lot stock number is transmitted to the securities exchange system 7, the round lot stock ordering unit 33 stores information concerning the selling order of the round lot stock number (including the stock price information and etc.) into the storage device. If it is judged at the step S39 that n is less than x, processing returns to step S31.

As described above, if the threshold x is determined and the selling order of the round lot stock number is executed for the securities exchange before the number of the total ordered stocks does not reach the round lot stock number, the securities firm can settle the selling orders of the odd lot from the investors in an earlier stage compared with the conventional art. However, since the maximum loss caused by the selling remainder is covered by the trading fee, the risk of the securities firm becomes low.

In this embodiment, since the selling order of the round lot stock number is executed for the securities exchange before the number of the total selling order stocks does not reach the round lot stock number, the selling order insufficiency m is not zero even if the selling order is executed for the securities exchange. Therefore, the order receiving and managing unit 31 of the odd lot broker system 3 accepts the selling order from the counter terminal 9, the customer terminal 11 and 13, and the same trading broker system 5 until the selling order insufficiency m becomes 0 in principal to dispose of the selling remainder (step S43). However, the order receiving and managing unit 31 does not always reject the selling order at the moment when the selling order insufficiency m becomes 0. An investor may make an order whose stock number exceeds the selling order insufficiency m, and a plurality of investors may almost simultaneously make orders and the orders may make the selling order insufficiency m 0. In such cases, the order receiving and managing unit 31 accepts the selling orders. Information concerning the received selling order is stored into the storage device. In addition, it is possible to limit acceptances of the selling orders before a predetermined timing t2. For example, the predetermined timing t2 is the end of the business hours.

If the selling order insufficiency m becomes 0 until the predetermined timing t2, the order receiving and managing unit 31 rejects the selling orders from the same trading broker system 5 (step S45). On the other side, it is possible to accept the selling orders from the investors because of the customer service even if the selling order insufficiency m becomes 0. If the selling order is rejected, even when the stock code is clicked, for example, in FIG. 3, a screen as shown in FIG. 6 is displayed. That is, the display contents are almost unchanged from FIG. 2 to FIG. 3. However, on the screen, the volume of the order cannot be changed and the button for transmission cannot be clicked. Here, only the cancel button can be clicked.

Then, the order receiving and managing unit 31 judges whether the number n of the total selling order stocks exceeds the round lot stock number until the predetermined timing t2 (step S47). If the number n of the total selling order stocks exceeds the round lot stock number, the stock providing processing unit 37 performs the stock providing processing which will be explained using FIG. 11 (step S49). On the other hand, if the number n of the total selling order stocks is equal to or less than the round lot stock number, the order receiving and managing unit 31 provides stocks according to each selling order, and stores information concerning the stock settlement state into the storage device (step S51).

After step S49 or step S51, in accordance with the stock settlement state, each odd lot selling order is settled and an amount of money, which the investor has to pay, is calculated by adding the price for stocks and the trading fee and tax, and the settlement statement is issued for the investor (step S53).

Then, it is judged whether processing has to be ended (step S55). If processing has to continue, it returns to step S31. If it is judged that the processing has to be ended, go to end.

By performing such a processing, the odd lot order can be settled even if the number of the total ordered stocks of the odd lot does not reach the round lot stock number. In addition, the customer service can be improved.

Next, the details of step S39 are explained using FIG. 11. The stock providing processing unit 37 firstly judges whether or not it is possible to provide the minimum number of ordered stocks among the accepted selling orders to all investors who made the selling orders (step S81). If it is possible to provide the minimum number of ordered stocks to all investors, the stock providing processing unit 37 provides the minimum number of ordered stocks to all investors, and stores information concerning the settlement state (step S83). On the other side, if it is impossible to provide the minimum number of ordered stocks among the received selling orders to all investors, first of all, one stock is provided to all investors and stores information concerning the settlement state (step S85). For example, if the selling orders are accepted from 4 investors and the minimum number of ordered stocks is 300 stocks, the provided stocks becomes 1200 stocks and exceeds the round lot stock number when 300 stocks are provided to 4 investors. In such a case, it is impossible to provide the minimum number of ordered stocks. Therefore, one stock is provided to 4 investors at step S85.

After step S83 or step S85, the stock providing processing unit 37 provides the stocks, which is unassigned by the processing at step S83 or S85, by the weighted average of the remainder of the order to each investor who has the remainder of the order, and stores information concerning the providing state into the storage device (step S87). Then, the stock providing processing unit 37 judges whether or not it is possible to provide all of the round lot stocks by the processing step S63 or S65 and step S67 (step S89). If it is possible to provide all of the round lot stocks, the providing state and the remainder number of the ordered stocks are stored for each investor into the storage device (step S93). On the other side, if it is not possible to provide all of the round lot stock number and the remainder occurs, processing for adjusting the remainder is performed (step S91). Then, step S93 is performed.

The odd lot broker system 3 and the same trading broker system 5 are programmed to perform processing shown in FIGS. 2 and 7 and FIGS. 10 and 11.

The threshold x has some variations as follows:

(1) In the above description, the threshold x is calculated so that the maximum loss caused by the buying remainder or the selling remainder is under the trading fee. This supposes a state in which the stock price becomes 0. However, ordinarily, there is little possibility that the stock price suddenly becomes 0. Therefore, instead of the maximum loss caused by the buying remainder or the selling remainder, (the limited price range within one day)*(the stock number of the buying remainder or the selling remainder) can be substituted as the risk amount. For example, if the rate of the trading fee is 3% and the stock price is 9000 Yen, an expression of inequality is (the limited price range with in one day)*(1000−x)<9000*0.03x. If the limited price range within one day is 100 Yen, the inequality is solved as 270.3<x. Therefore, if the number of the total ordered stocks of the odd lot becomes 271, the buying or selling order is output to the securities exchange system 7.

(2) If the number of odd lot orders by investors is equal to or higher than 1000 times on previous day, at least one order is transmitted within one day to the securities exchange system 7. Therefore, the initial value of the threshold x may be 900 stocks, for example. Because the liquidity is high, even if the threshold x is lowered, there is low possibility that the buying remainder or the selling remainder occurs and it is considered that the risk amount is also low.

(3) For example, if the stock volume, which is traded during one week and is an object of the odd lot trading, is 100000 stocks, the threshold x is lowered to 900 stocks, for example. In addition, if the stock volume is 500000 stocks, the threshold x is lowered to 800 stocks, and if the stock volume is 1000000 stocks, the threshold x is lowered to 700 stocks, for example.

In this case, because the liquidity is high, even if the threshold x is lowered, there is low possibility that the buying remainder or the selling remainder occurs and it is considered that the risk amount is also low.

The round lot stock number is not only 1000, but also is 10, 50, 100, 200, 500, 2000 3000 and so on.

The above description includes some variations for the threshold x, but other variations are possible. For example, in FIG. 1, only one same trading broker system 5 is shown, but a plurality of same trading broker systems may be provided. On the other hand, there may be no same trading broker system 7. In this case, step S15 in FIG. 2 and step S45 in FIG. 10 are not performed.

In addition, in the processing flow shown in FIG. 7 or FIG. 11, the minimum number of the ordered stocks is provided to all investors at step S63 or step S83. However, for example, there is a case in which one investor makes a plurality of odd lot orders. Therefore, in this case, the minimum number of the ordered stocks may be provided to each order, or may be provided to each investor by accumulating all odd lot orders which one investor makes.

Furthermore, the above described system can be implemented by installing a dedicated program into computer hardware. In this case, this program is stored in a storage medium, a recording medium, or a storage device, for example, a floppy disk, CD-ROM, magneto optic disk, semiconductor memory, hard disk and etc. The program may be transmitted through the network 1, for example, the Internet. Intermediate processing result is temporarily stored into a memory, for example, a main memory.

As described above, the present invention can provide technology that enable the securities firm to appropriately execute trading orders of the odd lot without making the price fluctuation risk and etc. come to the surface.

In addition, the present invention can also provide a new method for providing stocks to each order if the number of the total ordered stocks of the odd lot is over the round lot stock number.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A method for supporting a trading of an odd lot that is less than a round lot stock number determined in every stock company, said method comprising the steps of:
receiving from a customer, an odd lot selling order or an odd lot buying order for a particular stock company;
judging whether or not a number of total stocks of said odd lot selling orders or a number of total stocks of said odd lot buying orders received at said receiving step is over a threshold value that is less than said round lot stock number and is determined by a predetermined rule; and
if it is judged at said judging step that the number of total stocks of said odd lot selling orders or the number of total stocks of said odd lot buying orders is over said threshold, outputting a selling order of said round lot stock number defined for said particular stock company for said odd lot selling orders or a buying order of said round lot stock number defined for said particular stock company for said odd lot buying orders.

2. The method set forth in claim 1, wherein said predetermined rule is a rule in which a trading fee of said odd lot buying orders or said odd lot selling orders is equal to or higher than a risk amount for a stock number which is a difference between said round lot stock number and said threshold.

3. The method set forth in claim 2, wherein said risk amount is determined by a limited price range or a price itself.

4. The method set forth in claim 1, wherein said predetermined rule is a rule based on a trading volume of stocks of said particular stock company during a predetermined period.

5. The method set forth in claim 1, further comprising the steps of:
judging whether or not said number of said total stocks of said odd lot buying orders or said number of said total stocks of said odd lot selling orders that are received at said receiving step is over said round lot stock number of said particular stock company;
if it is judged at said second judging step that said number of said total stocks of said odd lot buying orders or said number of said total stocks of said odd lot selling orders is over said round lot stock number, providing a minimum number of ordered stocks of said odd lot buying orders or said odd lot selling orders to each customer who makes said odd lot buying order or said odd lot selling order; and
providing a number of remainder stocks that is calculated by subtracting a number of all stocks provided at said first providing step from said round lot stock number, to a customer who has a remainder of the order, according to a second predetermined rule.

6. The method set forth in claim 1, further comprising the steps of:
judging whether or not said number of said total stocks of said odd lot buying orders or said number of said total stocks of said odd lot selling orders that are received at said receiving step is over said round lot stock number of said particular stock company;
if it is judged at said second judging step that said number of said total stocks of said odd lot buying orders or said number of said total stocks of said odd lot selling orders is over said round lot stock number, judging whether or not it is possible to provide a minimum number of ordered stocks of said odd lot buying orders or said odd lot selling orders to each customer who makes said odd lot buying order or said odd lot selling order;
if it is judged at said third judging step that it is impossible to provide, providing one stock to said each customer; and
providing a number of remainder stocks that is calculated by subtracting a number of all stocks provided at said first providing step from said round lot stock number, to a customer who has a remainder of the order, according to a second predetermined rule.

7. A method for supporting a trading of an odd lot that is less than a round lot stock number determined in every stock company, said method comprising the steps of:
judging whether or not a number of total stocks of odd lot buying orders or a number of total stocks of odd lot selling orders that are received from customers is over said round lot stock number of said particular stock company;
if it is judged at said judging step that said number of said total stocks of said odd lot buying orders or said number of said total stocks of said odd lot selling orders is over said round lot stock number, judging whether or not it is possible to provide a minimum number of ordered stocks of said odd lot buying orders or said odd lot selling orders to each customer who makes said odd lot buying order or said odd lot selling order;
if it is judged at said second judging step that it is possible to provide, providing said minimum number of said ordered stocks of said odd lot buying orders or said odd lot selling orders to said each customer who makes said odd lot buying order or said odd lot selling order; and
providing a number of remainder stocks that is calculated by subtracting a number of all stocks provided at said first providing step from said round lot stock number, to a customer who has a remainder of the order, according to a second predetermined rule.

8. The method set forth in claim 7, further comprising the steps of:
if it is judged at said second judging step that it is impossible to provide, providing one stock to said each customer; and
providing a number of remainder stocks that is calculated by subtracting a number of all stocks provided at said first providing step from said round lot stock number, to a customer who has a remainder of the order, according to a second predetermined rule.

9. A storage medium for storing a program for causing a computer to support a trading of an odd lot that is less than a round lot stock number determined in every stock company, said program comprising the steps of:
receiving from a customer, an odd lot selling order or an odd lot buying order for a particular stock company;
judging whether or not a number of total stocks of said odd lot selling orders or a number of total stocks of said odd lot buying orders received at said receiving step is over a threshold value that is less than said round lot stock number and is determined by a predetermined rule; and
if it is judged at said judging step that the number of total stocks of said odd lot selling orders or the number of total stocks of said odd lot buying orders is over said threshold, outputting a selling order of said round lot stock number defined for said particular stock company for said odd lot selling orders or a buying order of said round lot stock number defined for said particular stock company for said odd lot buying orders.

10. The storage medium set forth in claim 9, wherein said predetermined rule is a rule in which a trading fee of said odd lot buying orders or said odd lot selling orders is equal to or higher than a risk amount for a stock number which is a difference between said round lot stock number and said threshold.

11. The storage medium set forth in claim 10, wherein said risk amount is determined by a limited price range or a price itself.

12. The storage medium set forth in claim 9, wherein said predetermined rule is a rule based on a trading volume of stocks of said particular stock company during a predetermined period.

13. The storage medium set forth in claim 9, said program further comprising the steps of:
judging whether or not said number of said total stocks of said odd lot buying orders or said number of said total stocks of said odd lot selling orders that are received at said receiving step is over said round lot stock number of said particular stock company;
if it is judged at said second judging step that said number of said total stocks of said odd lot buying orders or said number of said total stocks of said odd lot selling orders is over said round lot stock number, providing a minimum number of ordered stocks of said odd lot buying orders or said odd lot selling orders to each customer who makes said odd lot buying order or said odd lot selling order; and
providing a number of remainder stocks that is calculated by subtracting a number of all stocks provided at said first providing step from said round lot stock number, to a customer who has a remainder of the order, according to a second predetermined rule.

14. The storage medium set forth in claim 9, said program further comprising the steps of:
judging whether or not said number of said total stocks of said odd lot buying orders or said number of said total stocks of said odd lot selling orders that are received at said receiving step is over said round lot stock number of said particular stock company;
if it is judged at said second judging step that said number of said total stocks of said odd lot buying orders or said number of said total stocks of said odd lot selling orders is over said round lot stock number, judging whether or not it is possible to provide a minimum number of ordered stocks of said odd lot buying orders or said odd lot selling orders to each customer who makes said odd lot buying order or said odd lot selling order;
if it is judged at said third judging step that it is impossible to provide, providing one stock to said each customer; and
providing a number of remainder stocks that is calculated by subtracting a number of all stocks provided at said first providing step from said round lot stock number, to a customer who has a remainder of the order, according to a second predetermined rule.

15. A storage medium for storing a program for causing a computer to support a trading of an odd lot that is less than a round lot stock number determined in every stock company, said program comprising the steps of:
judging whether or not a number of total stocks of odd lot buying orders or a number of total stocks of odd lot selling orders that are received from customers is over said round lot stock number of said particular stock company;
if it is judged at said judging step that said number of said total stocks of said odd lot buying orders or said number of said total stocks of said odd lot selling orders is over said round lot stock number, judging whether or not it is possible to provide a minimum number of ordered stocks of said odd lot buying orders or said odd lot selling orders to each customer who makes said odd lot buying order or said odd lot selling order;
if it is judged at said second judging step that it is possible to provide, providing said minimum number of said ordered stocks of said odd lot buying orders or said odd lot selling orders to said each customer who makes said odd lot buying order or said odd lot selling order; and
providing a number of remainder stocks that is calculated by subtracting a number of all stocks provided at said first providing step from said round lot stock number, to a customer who has a remainder of the order, according to a second predetermined rule.

16. The storage medium set forth in claim 15, said program further comprising the steps of:
if it is judged at said second judging step that it is impossible to provide, providing one stock to said each customer; and
providing a number of remainder stocks that is calculated by subtracting a number of all stocks provided at said first providing step from said round lot stock number, to a customer who has a remainder of the order, according to a second predetermined rule.

17. A system for supporting a trading of an odd lot that is less than a round lot stock number determined in every stock company, comprising:
means for receiving from a customer, an odd lot selling order or an odd lot buying order for a particular stock company;
means for judging whether or not a number of total stocks of said odd lot selling orders or a number of total stocks of said odd lot buying orders received by said means for receiving is over a threshold value that is less than said round lot stock number and is determined by a predetermined rule; and
means for outputting a selling order of said round lot stock number defined for said particular stock company for said odd lot selling orders or a buying order of said round lot stock number defined for said particular stock company for said odd lot buying orders if it is judged by said means for judging that the number of total stocks of said odd lot selling orders or the number of total stocks of said odd lot buying orders is over said threshold.

18. The system set forth in claim 17, wherein said predetermined rule is a rule in which a trading fee of said odd lot buying orders or said odd lot selling orders is equal to or higher than a risk amount for a stock number which is a difference between said round lot stock number and said threshold.

19. The system set forth in claim 18, wherein said risk amount is determined by a limited price range or a price itself.

20. The system set forth in claim 17, wherein said predetermined rule is a rule based on a trading volume of stocks of said particular stock company during a predetermined period.

21. The system set forth in claim 18, further comprising:
second judging means for judging whether or not said number of said total stocks of said odd lot buying orders or said number of said total stocks of said odd lot selling orders that are received by said means for receiving is over said round lot stock number of said particular stock company;
first providing means for providing a minimum number of ordered stocks of said odd lot buying orders or said odd lot selling orders to each customer who makes said odd lot buying order or said odd lot selling order if it is judged by said second judging means that said number of said total stocks of said odd lot buying orders or said number of said total stocks of said odd lot selling orders is over said round lot stock number; and
second providing means for providing a number of remainder stocks that is calculated by subtracting a number of all stocks provided by said first providing means from said round lot stock number, to a customer who has a remainder of the order, according to a second predetermined rule.

22. The system set forth in claim 17, further comprising:
second judging means for judging whether or not said number of said total stocks of said odd lot buying orders or said number of said total stocks of said odd lot selling orders that are received by said means for receiving is over said round lot stock number of said particular stock company;
third judging means for judging whether or not it is possible to provide a minimum number of ordered stocks of said odd lot buying orders or said odd lot selling orders to each customer who makes said odd lot buying order or said odd lot selling order if it is judged by said second judging means that said number of said total stocks of said odd lot buying orders or said number of said total stocks of said odd lot selling orders is over said round lot stock number; first providing means for providing one stock to said each customer if it is judged at said third judging means that it is impossible to provide; and
second providing means for providing a number of remainder stocks that is calculated by subtracting a number of all stocks provided by said first providing means from said round lot stock number, to a customer who has a remainder of the order, according to a second predetermined rule.

23. A system for supporting a trading of an odd lot that is less than a round lot stock number determined in every stock company, comprising:
first judging means for judging whether or not a number of total stocks of odd lot buying orders or a number of total stocks of odd lot selling orders that are received from customers is over said round lot stock number of said particular stock company;
second means for judging whether or not it is possible to provide a minimum number of ordered stocks of said odd lot buying orders or said odd lot selling orders to each customer who makes said odd lot buying order or said odd lot selling order if it is judged by said first judging means that said number of said total stocks of said odd lot buying orders or said number of said total stocks of said odd lot selling orders is over said round lot stock number;
first providing means for providing said minimum number of said ordered stocks of said odd lot buying orders or said odd lot selling orders to said each customer who makes said odd lot buying order or said odd lot selling order if it is judged by said second judging means that it is possible to provide; and
second providing means for providing a number of remainder stocks that is calculated by subtracting a number of all stocks provided at said first providing step from said round lot stock number, to a customer who has a remainder of the order, according to a second predetermined rule.

24. The system set forth in claim 23, further comprising:
third providing means for providing one stock to said each customer if it is judged by said second judging means that it is impossible to provide; and
forth providing means for providing a number of remainder stocks that is calculated by subtracting a number of all stocks provided at said first providing step from said round lot stock number, to a customer who has a remainder of the order, according to a second predetermined rule.
